(19) United States
(12) Patent Application Publication
(10) Pub. No.: US 2021/0269238 A1
(43) Pub. Date: Sep. 2, 2021

(54) ACTUATING GARBAGE BIN LID AND ACTUATING GARBAGE BIN

(71) Applicant: Michael SHEK, San Mateo, CA (US)

(72) Inventor: Michael SHEK, San Mateo, CA (US)

(21) Appl. No.: 16/805,021

(22) Filed: Feb. 28, 2020

(51) Int. Cl. B65F 1/16; B65F 1/14

(52) U.S. Cl. CPC B65F 1/1638; B65F 2210/168; B65F 1/1421

(57) ABSTRACT

An actuating garbage bin lid includes a frame, a lid body, a plurality of engaging units, and a control unit. The frame encloses an inlet opening. The lid body is pivotally connected to the frame to selectively cover the inlet opening. The driving unit is disposed on the frame to drive the lid body to pivot. Each of the engaging units includes a positioning assembly and a communication cable. The positioning assembly is disposed on the frame. A first end of the communication cable is electrically connected to the driving unit. The control unit is connected to one of the engaging units and includes a first member fixed to the positioning assembly and a sensor electrically connected to a second end of the communication cable. The sensor is adapted for being actuated and sends signals via the communication cable to control the driving unit.

### BACKGROUND OF THE INVENTION

### Field of the Invention

The present invention relates to a garbage bin, more especially to an actuating garbage bin lid and an actuating garbage bin including the same.

### Description of the Prior Art

The conventional garbage bin usually has a lid which has to be opened manually. As a result, the hands of the user may be contaminated by the lid. Thus, a garbage bin having a lid which is able to be opened by stepping on a pedal can solve the problem. Nowadays, the garbage bin lid can be opened by actuating means such as pressing, infrared light, or sound.

However, the actuating mechanism is arranged at the specific position according to a general way to use. The garbage bin has to be placed at the specific position at the specific orientation. Thus, the garbage bin cannot be placed at any position that the user wants, and the garbage bin lid cannot be actuated to open from any direction which is convenient for the user.

### SUMMARY OF THE INVENTION

The main object of the present invention is to provide an actuating garbage bin lid and an actuating garbage bin including the same. The frame of the actuating garbage bin lid has a plurality of engaging units for the control unit to selectively connect to so that the position of the control unit can be changed according to the surrounding.

To achieve the above and other objects, the actuating garbage bin lid of the present invention includes a frame, a lid body, a driving unit, a plurality of engaging units, and a control unit.

The frame encloses an inlet opening. The lid body is pivotally connected to the frame to selectively cover the inlet opening. The driving unit is disposed on the frame to drive the lid body to pivot. Each of the engaging units includes a positioning assembly and a communication cable. The positioning assembly is disposed on the frame. A first end of the communication cable is electrically connected to the driving unit. The control unit is connected to one of the engaging units and includes a first member and a sensor. The first member is fixed to the positioning assembly. The sensor is electrically connected to a second end of the communication cable. The sensor is adapted for being actuated and sends signals via the communication cable to control the driving unit.

To achieve the above and other objects, the actuating garbage bin of the present invention includes the actuating garbage bin lid mentioned above, and further includes a bin.

The bin includes a bin body and a bin bottom. The bin body is disposed on the bin bottom. A receiving space is enclosed by the bin body and the bin bottom. The bin body is cylinder-shaped. An end of the bin body has a positioning portion. The bin bottom has a receiving groove extending circumferentially and a plurality of stopping portions. The plurality of stopping portions are formed on a lateral wall of the receiving groove. Each of the stopping portions have an inclined guiding face and a stopping face connected together. The positioning portion slides on the inclined guiding face along a second direction to enter the receiving groove. The second direction is perpendicular to the first direction.

When the positioning portion entered the receiving groove, the stopping face stops and abuts against the positioning portion along the second direction in order to prevent the positioning portion from leaving the receiving groove. When the actuating garbage bin lid is installed onto the bin, the inlet opening communicates the receiving space.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is an A-A profile;

FIG. 4 is a partial enlargement of FIG. 3;

FIG. 5 is an other partial enlargement of FIG. 3;

FIG. 6 is a B-B profile;

FIG. 7 is a breakdown drawing showing a control unit and an engaging unit of the present invention;

FIG. 8 is an illustration of the present invention.

### DETAILED DESCRIPTION OF THE PREFERRED EMBODIMENTS

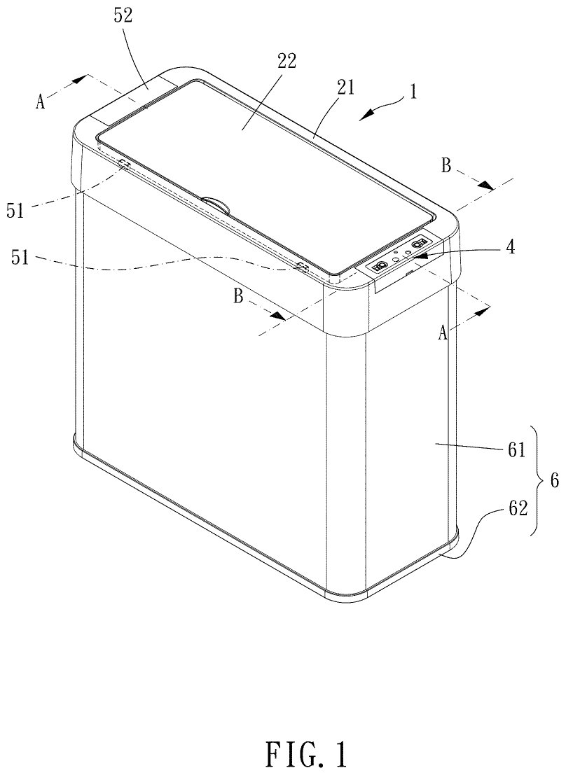

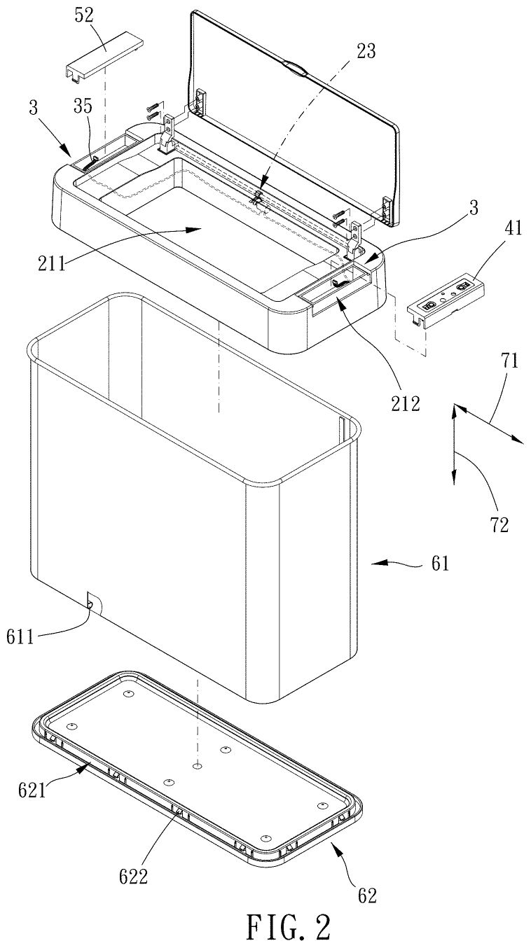

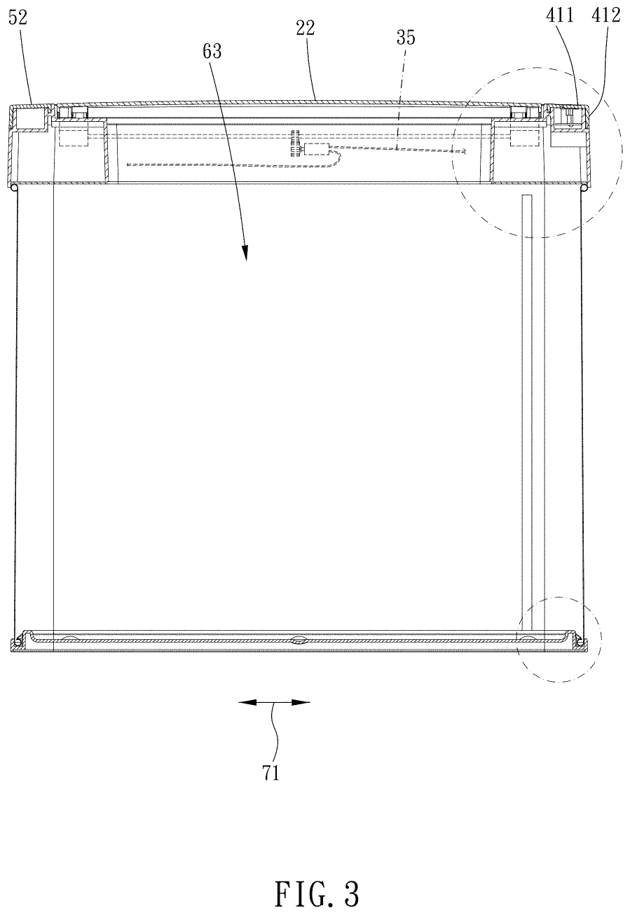

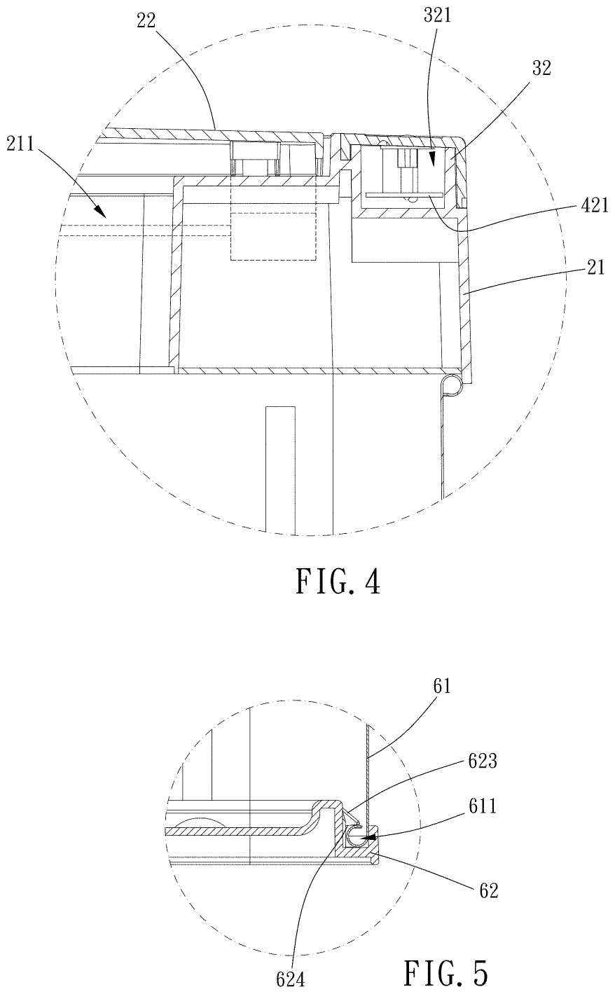

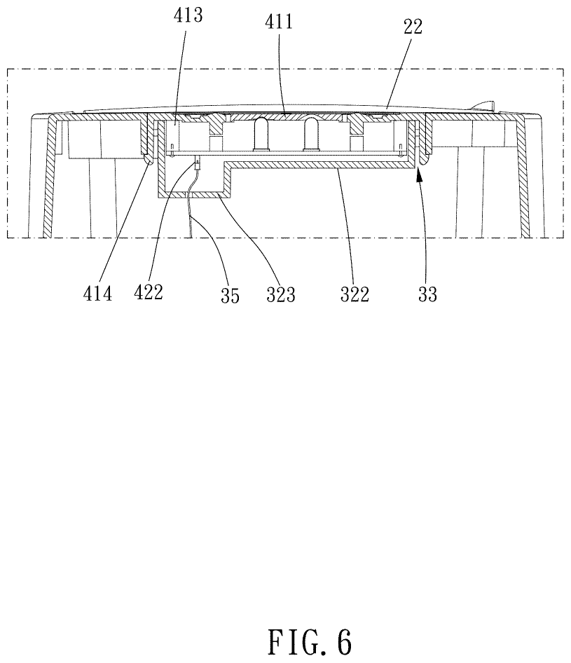

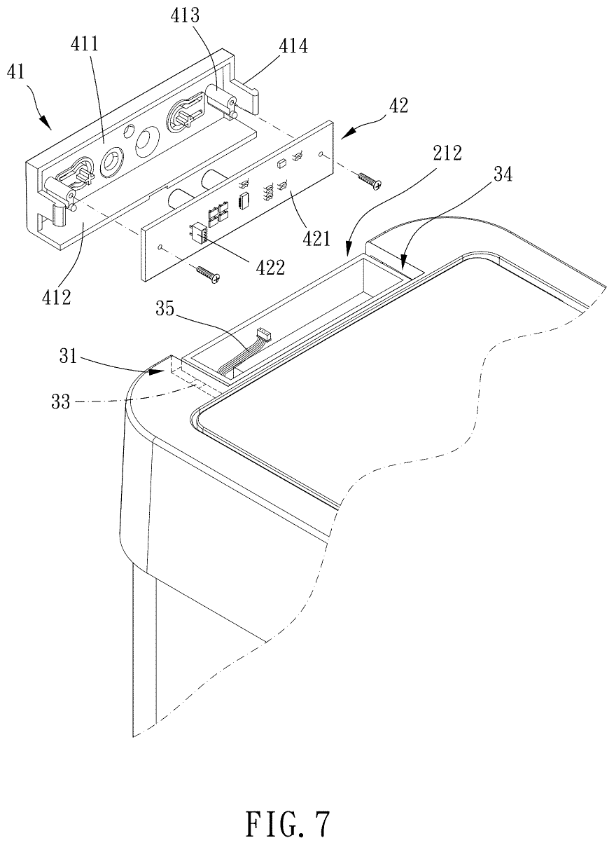

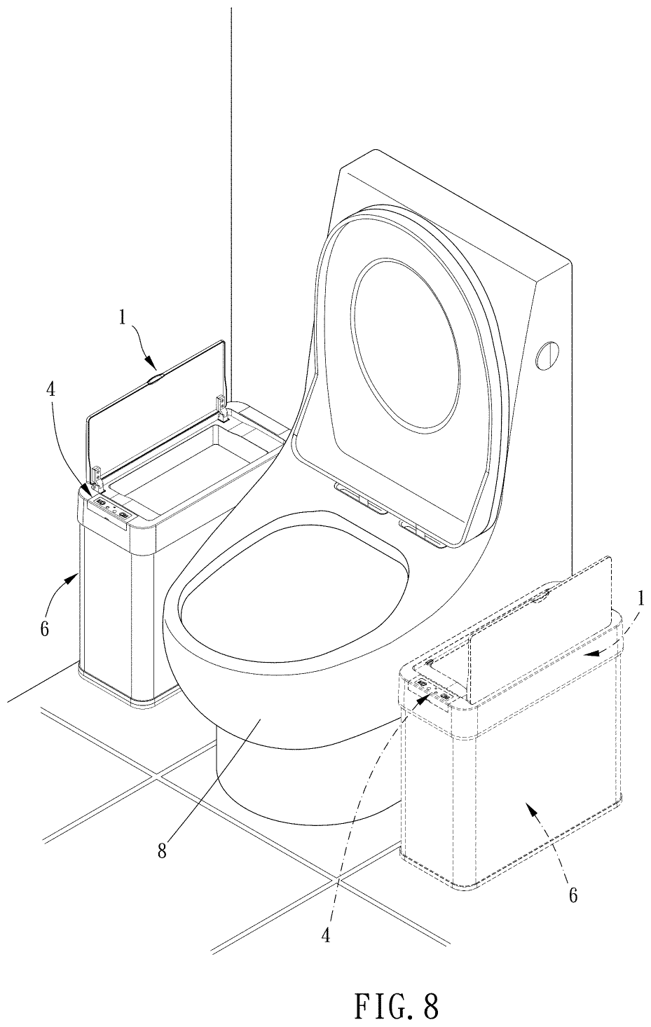

Please refer to FIG. 1 to FIG. 8, the actuating garbage bin lid of the present invention includes a frame 21, a lid body, 22, a driving unit 23, a plurality of engaging units 3, and a control unit 4.

The frame 21 encloses an inlet opening 211. The lid body 22 is pivotally connected to the frame 21 to selectively cover the inlet opening 211. The driving unit 23 is disposed on the frame 21 to drive the lid body 22 to pivot. Each of the engaging units 3 includes a positioning assembly 31 and a communication cable 35. The positioning assembly 31 is disposed on the frame 21. A first end of the communication cable 35 is electrically connected to the driving unit 23. The control unit 4 is connected to one of the engaging units 3 and includes a first member 41 and a sensor 42. The first member 41 is fixed to the positioning assembly 31. The sensor 42 is electrically connected to a second end of the communication cable 35. The sensor 42 is adapted for being actuated and sends signals via the communication cable 35 to control the driving unit 23. Specifically, the sensor 42 can be actuated by pressing, infrared light, or sound.

In the present embodiment, the lid body 22 is pivotable around a first direction 71, and the plurality of engaging units 3 are arranged along the first direction 71. At least two of the engaging units 3 are located at two opposite sides of the lid body 22 respectively. That is, the lid body 22 is suitable to be placed beside an object 8, such as a toilet. The lid body 22 may open toward the user sat on the toilet to allow the user to throw the garbage into the garbage bin.

The positioning assembly 31 includes a receiving portion 32 disposed on the frame 21. The receiving portion 32 encloses an internal space 321. The second end of the communication cable 35 is inserted into the internal space 321. The sensor 42 is disposed on the first member 41. The first member 41 is adapted for covering the receiving portion 32 to make the sensor 42 be received in the internal space 321. Thereby, water, insects, or dust can be blocked by the first member 41 and the receiving portion 32 to protect the sensor 42. In the present embodiment, a length of the receiving portion 32 is 0.5-0.7 time a length of the lid body 22 along a direction perpendicular to the first direction 71. Thereby, the receiving portion 32 has sufficient space to receive different kinds of sensor.

Preferably, the positioning assembly 31 further includes two through holes 33 formed on the frame 21. The first member 41 further includes two hook members 414. The two hook members 414 correspond to the two through holes 33. When the first member 41 covers the receiving portion 32, the two hook portions 414 are inserted through the two through holes 33 to hook onto the frame 21. Thereby, the first member 41 can be firmly fixed onto the frame 21.

Specifically, the positioning assembly 31 further includes a surrounding groove 34 formed on the frame 21. The surrounding groove 34 surrounds the receiving portion 32 and penetrates a lateral side of the frame 21 to form an opening 212. The two through holes 33 are formed on a bottom of the surrounding groove 34. The two hook members 414 are inserted through the surrounding groove 34 and then inserted through the two through holes 33. That is, the two hook members 414 is clamped by the wall of the surrounding groove 34 and the wall of the receiving portion 32 so that the two hook members 414 are firmly restricted and supported to enhance the engagement.

More specifically, the first member 41 further includes a first covering plate 411 and a second covering plate 412 unparallel connected. The sensor 42 and the two hook members 414 are disposed on the first covering plate 411. In the present embodiment, the two hook members 414 are elastic and are formed integrally on the first covering plate 411. When the first member 41 covers the receiving portion 32, the first covering plate 411 covers the internal space 321, and the second covering plate 412 covers the opening 212 of the surrounding groove 34. Thus, the receiving portion 32 is protected from outside well. Besides, the first covering plate 411 abuts against the receiving portion 32 along a direction perpendicular to the first direction 71 (e.g. the vertical direction), and the second covering plate 412 abuts against the receiving portion 32 along the first direction 71. The receiving portion 32 is abutted against by the first covering plate 411, the second covering plate 412, and the hook members 414 along three different directions to enhance the engagement between the first member 41 and the positioning assembly 31.

The sensor 42 includes a circuit board 421 and a cable connector 422. The circuit board 421 is detachably disposed on the first member 41 and is located between the two hook members 414. The cable connector 422 is electrically connected to a side of the circuit board 421 facing the receiving portion 32. The cable connector 422 is adapted for electrically connecting to the second end of the communication cable 35. When the sensor 42 is actuated by pressing, hand-waving, or sound, the sensor 42 sends signals to the driving unit 23 via the cable connector 422 and the communication cable 35, and the driving unit 23 drives the lid body 22 to pivot with respect to the frame 21. Specifically, the circuit board 421 is located above the two hook members 414, and the communication cable 35 is located below the two hook members 414 to facilitate the second end of the communication cable 35 to connect to the cable connector 422. In the present embodiment, a plurality of protruded post members 413 are formed on the first covering plate 411. The circuit board 421 is screwed with the post members 413. The first covering plate 411 and the circuit board 421 are separated by the post members 413, and the structure of the first covering plate 411 is enhanced. In addition, the post members 413 can receive the bolts.

The receiving portion 32 includes a first bottom wall 322 and a second bottom wall 323. The first bottom wall 322 is higher than the second bottom wall 323 and is connected to the second bottom wall 323 via a stepped face. That is, the receiving portion 32 has a larger depth at a portion corresponding to the second bottom wall 323. The second end of the communication cable 35 penetrates the second bottom wall 323 to insert into the internal space 321. When the first member 41 covers the receiving portion 32, the cable connector 422 faces the second bottom wall 323.

In the present embodiment, the engaging units 3 include two said engaging units 3. The control unit 4 is disposed on one of the engaging units 3, and a second member 52 covers the other one of the engaging units 3. The receiving portion 32 of another said engaging unit 3 is protected by the second member 52. Besides, the second bottom walls 323 of the two engaging units 3 are arranged on two ends of a diagonal of the frame 21. Thus, no matter the actuating garbage bin lid 1 is placed at the right side or the left side of the object 8, the members such as buttons or switches of the control unit 4 are arranged in the same order.

Preferably, at least one cushion pad 51 is positioned on the frame 21. When the lid body 22 covers the inlet opening 211, the at least one cushion pad 51 abuts against the lid body 22 to reduce the shock and noise of the closing lid body 22. More specifically, the at least one cushion pad 51 is made of rubber.

The present invention further provides an actuating garbage bin including the actuating garbage bin lid 1 mentioned above. The actuating garbage bin further includes a bin 6. The bin 6 includes a bin body 61 and a bin bottom 62. The bin body 61 is disposed on the bin bottom 62, and a receiving space 63 is enclosed and defined by the bin body 61 and the bin bottom 62.

Specifically, the bin body 61 is cylinder-shaped. An end of the bin body 61 has a positioning portion 611. The bin bottom 62 has a receiving groove 621 extending circumferentially and a plurality of stopping portions 622. The plurality of stopping portions 622 are formed on a lateral wall of the receiving groove 621. Each of the stopping portions 622 has an inclined guiding face 623 and a stopping face 624 connected together. The positioning portion 611 slides on the inclined guiding face 623 along a second direction 72 to enter the receiving groove 621 wherein the second direction 72 is perpendicular to the first direction 71. When the positioning portion 611 entered the receiving groove 621, the stopping face 624 stops and abuts against the positioning portion 611 along the second direction 72 in order to prevent the positioning portion 611 from leaving the receiving groove 621. When the actuating garbage bin lid 1 is installed onto the bin 6, the inlet opening 211 communicates the receiving space 63.

In conclusion, the actuating garbage bin lid has several engaging units at different positions, so the control unit can be disposed on the desired one of the engaging units. Thereby, the garbage bin can be placed at the desired position at the desired orientation according to the surrounding of the object.

What is claimed is:

1. An actuating garbage bin lid, including:
a frame, enclosing an inlet opening;
a lid body, pivotally connected to the frame to selectively cover the inlet opening;
an driving unit, disposed on the frame to drive the lid body to pivot;
a plurality of engaging units, each of the engaging units including a positioning assembly and a communication cable, the positioning assembly being disposed on the frame, a first end of the communication cable being electrically connected to the driving unit;
a control unit, connected to one of the engaging units, including a first member and a sensor, the first member being fixed to the positioning assembly, the sensor being electrically connected to a second end of the communication cable, the sensor being adapted for being actuated and sending signals via the communication cable to control the driving unit.

2. The actuating garbage bin lid of claim 1, wherein the lid body is pivotable around a first direction, the plurality of engaging units are arranged along the first direction, at least two of the engaging units are located at two opposite sides of the lid body respectively.

3. The actuating garbage bin lid of claim 1, wherein the positioning assembly includes a receiving portion disposed on the frame, the receiving portion encloses an internal space, the second end of the communication cable is inserted into the internal space, the sensor is disposed on the first member, the first member is adapted for covering the receiving portion to make the sensor be received in the internal space.

4. The actuating garbage bin lid of claim 3, wherein the positioning assembly further includes two through holes formed on the frame, the first member further includes two hook members, the two hook members correspond to the two through holes; when the first member covers the receiving portion, the two hook portions are inserted through the two through holes to hook onto the frame.

5. The actuating garbage bin lid of claim 4, wherein the positioning assembly further includes a surrounding groove formed on the frame, the surrounding groove surrounds the receiving portion and penetrates a lateral side of the frame to form an opening, the two through holes are formed on a bottom of the surrounding groove, the two hook members are inserted through the surrounding groove and then inserted through the two through holes; the first member further includes a first covering plate and a second covering plate unparallel connected, the sensor and the two hook members are disposed on the first covering plate; when the first member covers the receiving portion, the first covering plate covers the internal space, the second covering plate covers the opening of the surrounding groove.

6. The actuating garbage bin lid of claim 4, wherein the sensor includes a circuit board and a cable connector, the circuit board is detachably disposed on the first member and is located between the two hook members, the cable connector is electrically connected to a side of the circuit board facing the receiving portion, the cable connector is adapted for electrically connecting to the second end of the communication cable; the circuit board is located above the two hook members, the communication cable is located below the two hook members.

7. The actuating garbage bin lid of claim 6, wherein the receiving portion includes a first bottom wall and a second bottom wall, the first bottom wall is higher than the second bottom wall and is connected to the second bottom wall via a stepped face, the second end of the communication cable penetrates the second bottom wall to insert into the internal space; when the first member covers the receiving portion, the cable connector faces the second bottom wall.

8. The actuating garbage bin lid of claim 1, wherein at least one cushion pad is positioned on the frame, when the lid body covers the inlet opening, the at least one cushion pad abuts against the lid body.

9. The actuating garbage bin lid of claim 6, wherein the lid body is pivotable around a first direction, the plurality of engaging units are arranged along the first direction, at least two of the engaging units are located at two opposite sides of the lid body respectively; the positioning assembly further includes a surrounding groove formed on the frame, the surrounding groove surrounds the receiving portion and penetrates a lateral side of the frame to form an opening, the two through holes are formed on a bottom of the surrounding groove, the two hook members are inserted through the surrounding groove and then inserted through the two through holes; the first member further includes a first covering plate and a second covering plate unparallel connected, the sensor and the two hook members are disposed on the first covering plate; when the first member covers the receiving portion, the first covering plate covers the internal space, the second covering plate covers the opening of the surrounding groove; at least one cushion pad is positioned on the frame, when the lid body covers the inlet opening, the at least one cushion pad abuts against the lid body; the engaging units includes two said engaging units, the control unit is disposed on one of the engaging units, a second member covers the other one of the engaging units; the second bottom walls of the two engaging units are arranged on two ends of a diagonal of the frame; a length of the receiving portion is 0.5-0.7 time a length of the lid body along a direction perpendicular to the first direction; the sensor is actuated by pressing or infrared light; the at least one cushion pad is made of rubber; a plurality of protruded post members are formed on the first covering plate, the circuit board is screwed with the post members; the two hook members are formed on the first covering plate integrally; the first covering plate abuts against the receiving portion along a direction perpendicular to the first direction, the second covering plate abuts against the receiving portion along the first direction.

10. An actuating garbage bin, including an actuating garbage bin lid of claim 1, further including:
a bin, including a bin body and a bin bottom, the bin body being disposed on the bin bottom, a receiving space being enclosed by the bin body and the bin bottom, the bin body being cylinder-shaped, an end of the bin body having a positioning portion, the bin bottom having a receiving groove extending circumferentially and a plurality of stopping portions, the plurality of stopping portions being formed on a lateral wall of the receiving groove, each of the stopping portions having an inclined guiding face and a stopping face connected together, the positioning portion sliding on the inclined guiding face along a second direction to enter the receiving groove, the second direction being perpendicular to the first direction;
wherein when the positioning portion entered the receiving groove, the stopping face stops and abuts against the positioning portion along the second direction in order to prevent the positioning portion from leaving the receiving groove;
wherein when the actuating garbage bin lid is installed onto the bin, the inlet opening communicates the receiving space.
